(19) United States
(12) Patent Application Publication
(10) Pub. No.: US 2004/0210370 A1
(43) Pub. Date: Oct. 21, 2004

(54) Method and apparatus for displaying an excavation to plan

(76) Inventors: Adam J. Gudat, Edelstein, IL (US); James J. Kalafut, Peoria, IL (US); Norman K. Lay, Dunlap, IL (US); Robert J. Price, Dunlap, IL (US)

Correspondence Address: Steve D. Lundquist, Caterpillar Inc.,, Intellectual Property Department, AB6490, 100 N.E. Adams Street, Peoria, IL, 61629-6490, US

(21) Appl. No.: 09/738,136

(22) Filed: Dec. 16, 2000

(51) Int. Cl. G01C 21/30

(52) U.S. Cl. 701/50; 701/210; 340/995.1

(57) ABSTRACT

A method and apparatus for providing a display in real time of an excavation site having underground objects. The method and apparatus includes determining a location of an earthworking machine in site coordinates, determining a location of an earthworking implement relative to the earthworking machine, determining the location in site coordinates of at least one underground object at the excavation site and responsively inputting the location of the at least one underground object to a terrain map of the excavation site, and displaying the terrain map including the location of the earthworking machine, the location of the earthworking implement, and the location of the at least one underground object in real time.

### TECHNICAL FIELD

This invention relates generally to a method and apparatus for displaying a terrain map of an excavation site in real time and, more particularly, to a method and apparatus for displaying a terrain map of an excavation site in real time including the location of underground objects.

### BACKGROUND ART

Earthworking machines, such as excavators, backhoe loaders, and the like, are often used to excavate the earth to desired parameters, i.e., to a desired depth in a select area. Historically, the excavation site was repeatedly surveyed and checked to insure that the proper depth was attained. A disadvantage of this method has been that the time and labor required to check the site slowed down operations considerably, thus increasing the overall cost of the excavation operation.

More recently, with the advent of technology, it is possible to monitor the progress of excavation with sensing equipment, and even display the results to an operator of the earthworking machine in real time. For example, in U.S. Pat. No. 5,631,658, Gudat et al. disclose a method and apparatus which monitors earthworking operations in real time using machine position and implement position sensors, and continually updates a display of the terrain as it is modified. The system of Gudat et al. furthermore compares this display to a display of a desired final condition of the terrain to allow an operator to modify the earth to match the actual terrain with the desired terrain.

More recently, in U.S. Pat. No. 5,864,060, Henderson et al. applies the fundamental concepts of Gudat et al. to an excavator-type of earthworking machine by displaying an icon of the excavator and associated work implement at the work site, and by coding the terrain, e.g., color coding, by depth relative to a desired depth, or by ore removed.

A disadvantage of the above exemplary patents, however, relates to the fact that much excavation is performed in the vicinity of underground objects, either to specifically dig to the objects, or to dig in spite of the objects so as not to disturb them. The display systems described above do not provide any method to monitor the excavation operation relative to the location of underground objects.

The present invention is directed to overcoming one or more of the problems as set forth above.

### DISCLOSURE OF THE INVENTION

In one aspect of the present invention a method for providing a display in real time of an excavation site having underground objects is disclosed. The method includes the steps of determining a location of an earthworking machine in site coordinates, determining a location of an earthworking implement relative to the earthworking machine, determining the location in site coordinates of at least one underground object at the excavation site and responsively inputting the location of the at least one underground object to a terrain map of the excavation site, and displaying the terrain map including the location of the earthworking machine, the location of the earthworking implement, and the location of the at least one underground object in real time.

In another aspect of the present invention an apparatus for providing a display in real time of an excavation site having underground objects is disclosed. The apparatus includes an earthworking machine having an earthworking implement controllably attached, a position determining system located on the earthworking machine, a terrain map of the excavation site, and means for determining the location in site coordinates of at least one underground object at the excavation site. The apparatus further includes a controller adapted to receive a signal from the position determining system and responsively determine a position in site coordinates of the earthworking machine and the earthworking implement, to receive a signal indicating the location of the at least one underground object, and to provide a real time update to the terrain map of the terrain, and the locations of the earthworking machine, the earthworking implement, and the at least one underground object. In addition, the apparatus includes a display adapted to receive a signal indicating the updated terrain map and to responsively display the location of the earthworking machine, the location of the earthworking implement, and the location of the at least one underground object.

### BRIEF DESCRIPTION OF THE DRAWINGS

FIG. 1 is a diagrammatic illustration of an earthworking machine at an excavation site;

FIG. 2 is a block diagram illustrating a preferred embodiment of the present invention;

FIG. 3 is a diagrammatic illustration of a display as embodied for use in the present invention;

FIG. 4 is a block diagram illustrating an aspect of the preferred embodiment of FIG. 2;

FIG. 5 is a block diagram illustrating another aspect of the preferred embodiment of FIG. 2;

FIG. 6 is a block diagram illustrating yet another aspect of the preferred embodiment of FIG. 2; and

FIG. 7 is a flow diagram illustrating a preferred method of the present invention.

### BEST MODE FOR CARRYING OUT THE INVENTION

Referring to the drawings, a method and apparatus 100 for providing a display 210 in real time of an excavation site 106 having underground objects 108 is disclosed. The excavation site 106 may be a construction site, a mining site, a location for digging specifically for underground objects, such as utility lines and pipes, storage tanks, and the like.

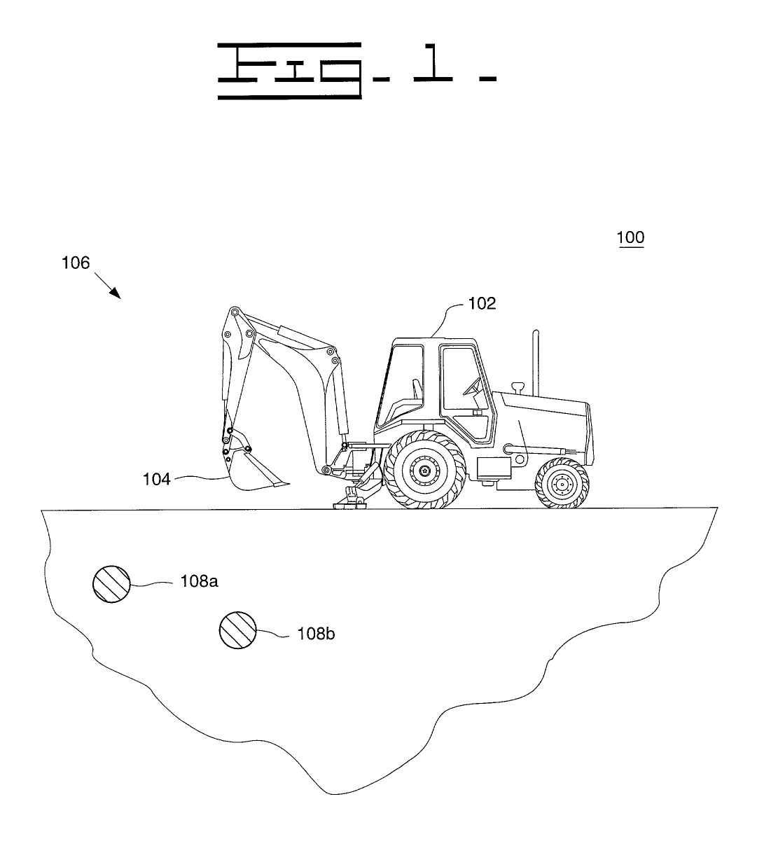

With particular reference to FIG. 1, an earthworking machine 102 having an earthworking implement 104 controllably attached is adapted to perform excavation at the excavation site 106. The earthworking machine 102 in FIG. 1 is depicted as a backhoe. However, other types of earthworking machines, such as excavators, front shovels, trenchers, and the like, may be used as well with the present invention. In addition, the earthworking implement 104 is shown as a bucket. However, other types of earthworking implements, e.g., shovels, blades, and the like, may be used.

At least one underground object 108 is located at the excavation site 106, for example in the ground at the location of excavation by the earthworking machine 102. FIG. 1 depicts two underground objects 108a, 108b. However, any number of underground objects 108 may exist in the proximity of the excavation work. The underground objects 108, as noted above, may be utility lines and pipes, such as electrical, telephone, gas, and the like. Alternatively, the underground objects 108 may be storage tanks, such as for fuel. It is highly desired to avoid interference with the underground objects 108 during excavation. For example, it may be desired to dig in close proximity to existing underground objects 108 for the purpose of adding new underground objects 108, performing repairs and maintenance on existing underground objects 108, or to perform excavation for purposes unrelated to the underground objects 108 themselves, such as digging a foundation, or a road.

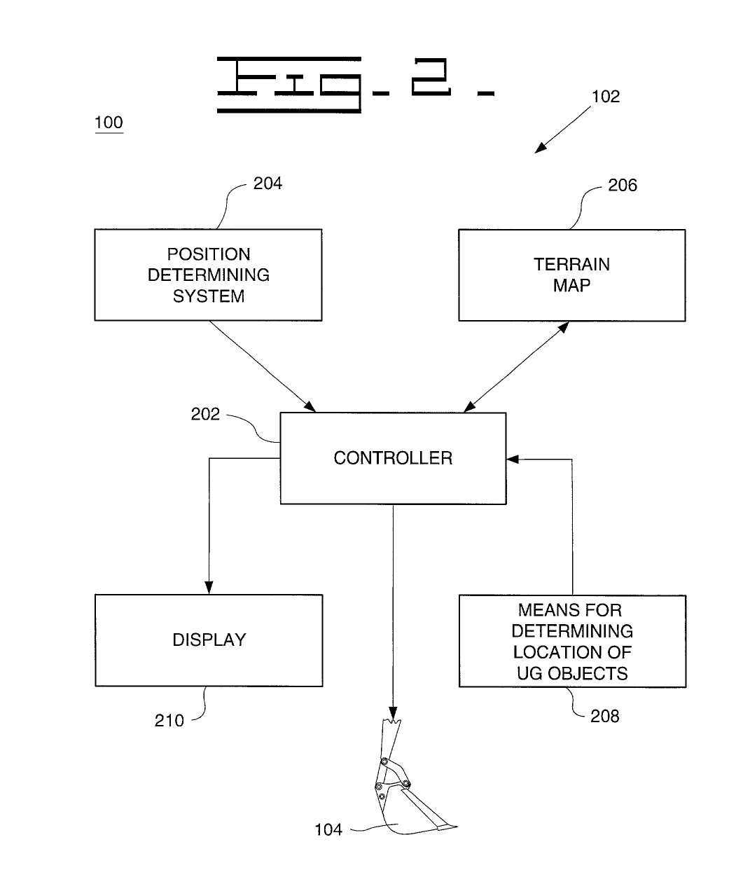

Referring to FIG. 2, a block diagram illustrating a preferred embodiment of the present invention is shown.

A position determining system 204, located on the earthworking machine 102, is adapted to determine the location, in site coordinates, of the earthworking machine 102. Moreover, the position determining system 204, by techniques well known in the art, may be used to determine the location in site coordinates of the earthworking implement 104. For example, the location of the earthworking implement 104 relative to the earthworking machine 102 may be determined by the use of resolvers and other position sensors located on the earthworking machine 102. Since the position determining system 204 is adapted to determine the position of the earthworking machine 102 in site coordinates, the position of the earthworking implement 104 in site coordinates may be determined as well. Alternatively, the position determining system 204 may be located on the earthworking implement 104 for direct determination of the position of the earthworking implement 104 in site coordinates.

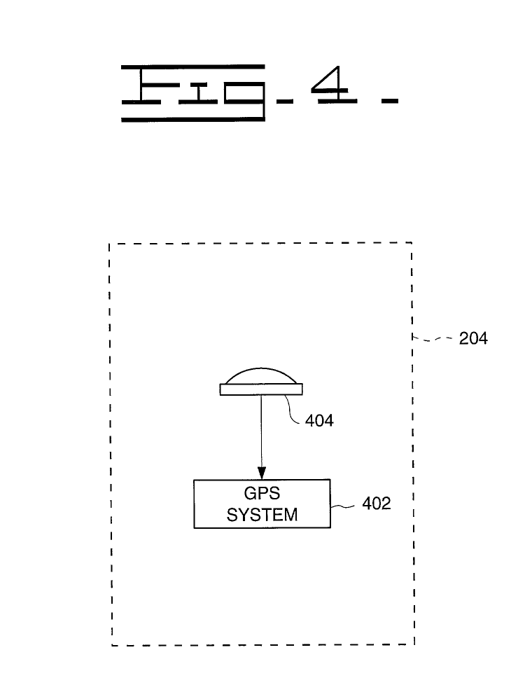

In the preferred embodiment, the position determining system 204, as shown in FIG. 4, includes a global positioning satellite (GPS) system 402 having a GPS antenna 404. However, other types of position determining systems 204, such as laser plane referencing, dead reckoning, and the like, may be used as well.

A terrain map 206 of the excavation site 106 provides information relevant to the terrain. For example, the ground elevation at various portions of the excavation site 106 is provided. Preferably, the terrain map 206 is contained in a database format for use with the present invention.

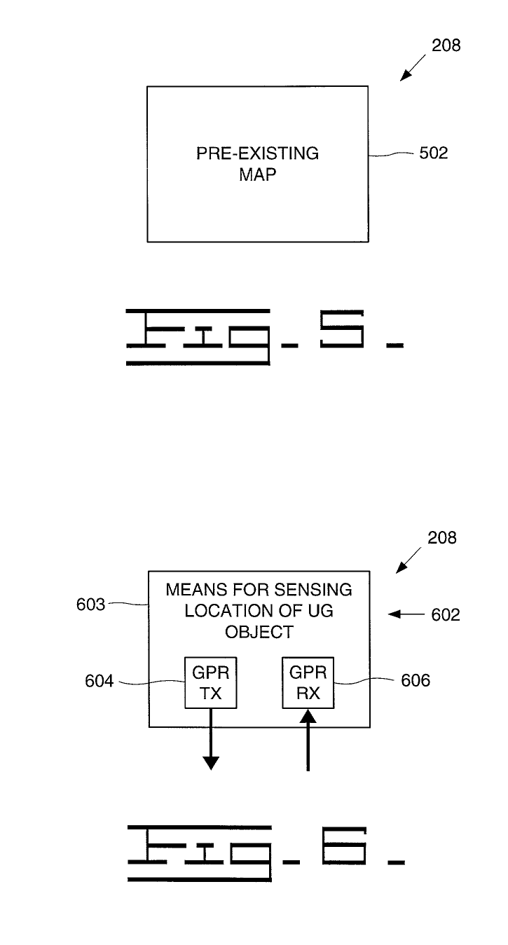

A means 208 for determining the location of underground objects 108, preferably in site coordinates, is provided. In one embodiment, the means 208 for determining the location of underground objects 108. as shown in FIG. 5, includes a pre-existing map 502. The pre-existing map 502 may be a map of the excavation site 106 from a prior installation of the underground objects 108, i.e., created when the underground objects 108 were initially installed, or may be a map generated from a prior sensing of the location of the underground objects 108. Preferably, in this embodiment, the pre-existing map 502 is in a database format compatible with the terrain map 206.

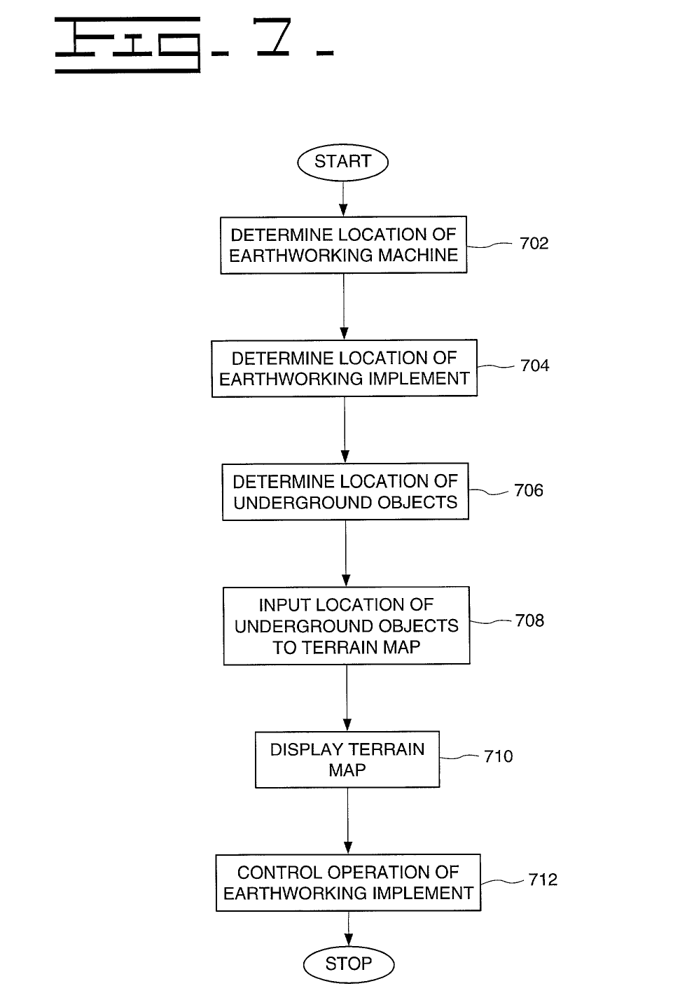

In an alternative embodiment, as shown in FIG. 6, the means 208 for determining the location of underground objects 108 may include a means 602 for sensing the location of underground objects 108. For example, a ground penetrating radar (GPR) system 603 having a GPR transmitter 604 and a GPR receiver 606 may be used. The GPR system 603 may be located on the earthworking machine 102 or may be located and used independently of the earthworking machine 102. GPR systems are well known in the art and therefore need not be further described.

Alternatively, the means 602 for sensing the location of underground objects 108 may include other technologies, such as acoustic, ultrasound, and the like.

A controller 202, located on the earthworking machine 102, is adapted to receive a signal from the position determining system 204 and responsively determine the position in site coordinates of the earthworking machine 102 and the earthworking implement 104. The controller 202 is also adapted to receive a signal indicating the location of any underground objects 108 from the means 208 for determining the location of underground objects 108. The controller 202 is also adapted to provide a real time update to the terrain map 206 of the terrain as excavation takes place, of the location of the earthworking machine 102, of the location of the earthworking implement 104, and of the location of the underground objects 108.

In a further embodiment, the controller 202 may be further adapted to control the operation of the earthworking implement 104 relative to the location of the underground objects 108, preferably for the purpose of preventing the earthworking implement 104 from contacting the underground objects 108.

A display 210, preferably located on the earthworking machine 102, is adapted to receive a signal from the controller 202 indicating the updated terrain map 206, and responsively display the location of the earthworking machine 102, the location of the earthworking implement 104, and the location of the underground objects 108.

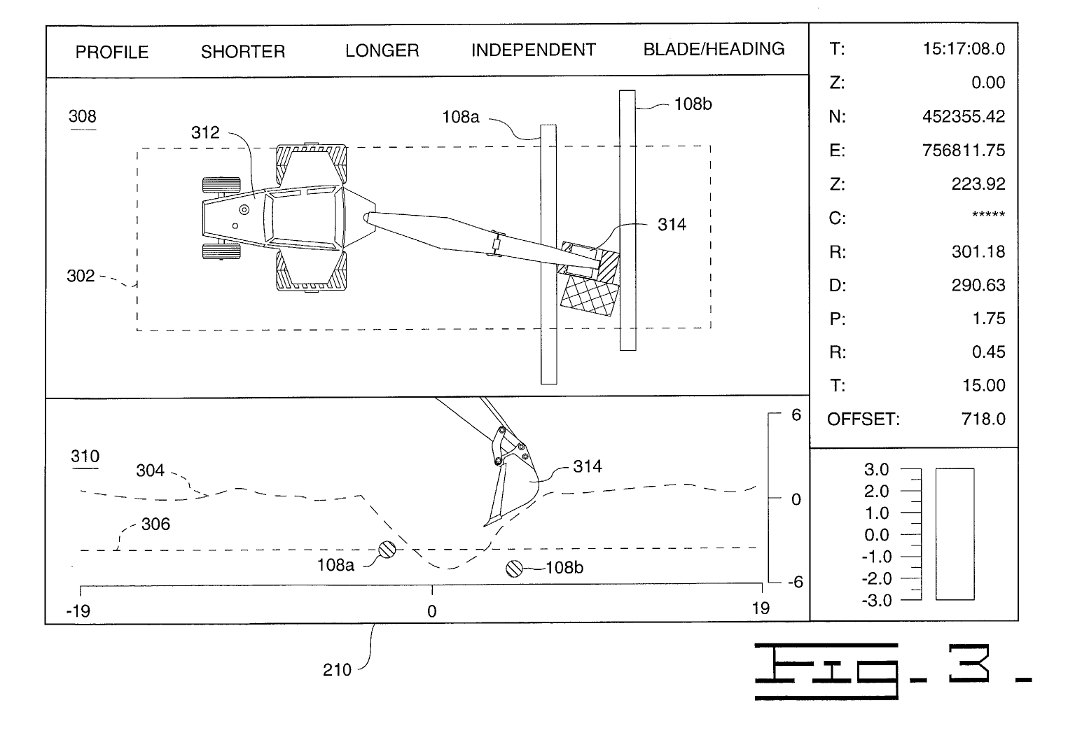

An exemplary display 210 is illustrated in FIG. 3. Preferably, the display 210 is adapted to show more than one view of the excavation site 106, for example a top view 308 and a side profile view 310. In addition, the display 210 preferably indicates, in addition to the current terrain 304, a desired terrain 306. The current terrain 304 and the desired terrain 306 provide an operator of the earthworking machine 102 with a reference for comparison. An icon 312 of the earthworking machine 102, and an icon 314 of the earthworking implement 314 are provided on the display 210. In addition, a set of plan lines 302 are indicated, to show an operator of the earthworking machine 102 where excavation is to take place.

Preferably, and as is well known in the art, various regions in the top view 308 are either color-coded or, as shown in FIG. 3, cross-hatched or gray-scaled to indicate the depth of the current terrain 304 relative to the desired terrain 306. For example, current terrain 304 that is higher than desired terrain 306 may be a first color, current terrain 304 that is lower than desired terrain 306 may be a second color, and current terrain 304 that is at the same level as desired terrain 306 may be a third color. This allow the operator to easily see the progress of excavation relative to the desired final result.

Referring to FIG. 7, a flow diagram illustrating a preferred method of the present invention is shown.

In a first control block 702, the location of the earthworking machine 102 is determined, preferably in site coordinates.

In a second control block 704, the location of the earthworking implement 104 relative to the earthworking machine 102 is determined.

In a third control block 706, the location of any underground objects 108 at the excavation site 106 is determined.

In a fourth control block 708, the determined location of the underground objects 108 are input to the terrain map 206. In addition, the determined locations of the earthworking machine 102 and the earthworking implement 104 are input to the terrain map 206.

In a fifth control block 710, the terrain map 206, in real time is displayed, including displays representing the locations of the earthworking machine 102, the earthworking implement 104, and the underground objects 108. In addition, the desired terrain 306 is displayed.

In a sixth control block 712, the operation of the earthworking implement 104 is controlled to prevent the earthworking implement 104 from contacting the underground objects 108.

### INDUSTRIAL APPLICABILITY

As an example of an application of the present invention, an earthworking machine 102, such as a backhoe loader or an excavator, is used to perform excavation operations. However, quite often underground objects 108 exist at the excavation site. For example, it may be desired to dig a trench for the purpose of burying a new utility line of some type, but care must be maintained due to the existence of other utility lines already buried nearby. This is a frequent concern when digging in utility easements.

Since digging in the proximity of existing lines requires great care, the excavation process is slowed down tremendously, thus resulting in lost time and increased costs. Furthermore, existing lines are frequently cut during excavation in spite of the careful digging, resulting in costly interruptions of utility service.

The present invention provides an operator of an earthworking machine 102 with a display of the location of the earthworking implement 104 relative to any underground objects 108, thus allowing for more efficient and reliable excavation.

Other aspects, objects, and features of the present invention can be obtained from a study of the drawings, the disclosure, and the appended claims.

1. A method for providing a display in real time of an excavation site having underground objects, including the steps of:
determining a location of an earthworking machine in site coordinates;
determining a location of an earthworking implement relative to the earthworking machine, the earthworking implement being controllably mounted to the earthworking machine;
determining the location in site coordinates of at least one underground object at the excavation site and responsively inputting the location of the at least one underground object to a terrain map of the excavation site; and
displaying the terrain map including the location of the earthworking machine, the location of the earthworking implement, and the location of the at least one underground object in real time.

2. A method, as set forth in claim 1, wherein displaying the terrain map includes the step of displaying a desired terrain.

3. A method, as set forth in claim 1, wherein determining the location of the earthworking machine includes the step of determining a position in site coordinates of a global positioning satellite (GPS) antenna located on the earthworking machine.

4. A method, as set forth in claim 2, wherein displaying the terrain map includes the step of displaying at least one icon representing the location of the earthworking machine and the earthworking implement.

5. A method, as set forth in claim 4, wherein displaying the terrain map includes the step of displaying at least one of a top view and a side profile view.

6. A method, as set forth in claim 1, wherein determining the location of the at least one underground object includes the steps of:
obtaining a map of the excavation site having the location of the at least one underground object as a function of at least one of a prior installation and a prior sensing of the at least one underground object; and
surveying the excavation site to verify the location of the at least one underground object.

7. A method, as set forth in claim 1, wherein determining the location of the at least one underground object includes the step of sensing the location of the at least one underground object.

8. A method, as set forth in claim 7, wherein sensing the location of the at least one underground object includes the step of transmitting a ground penetrating radar (GPR) signal into the earth and responsively receiving a reflected GPR signal.

9. A method, as set forth in claim 1, further including the step of controlling the operation of the earthworking implement relative to the location of the at least one underground object.

10. A method, as set forth in claim 9, wherein controlling the operation of the earthworking implement includes the step of preventing the earthworking implement from contacting the at least one underground object.

11. An apparatus for providing a display in real time of an excavation site having underground objects, comprising:
an earthworking machine having an earthworking implement controllably attached, the earthworking implement being adapted to perform excavation;
a position determining system located on the earthworking machine;
a terrain map of the excavation site;
means for determining the location in site coordinates of at least one underground object at the excavation site;
a controller adapted to receive a signal from the position determining system and responsively determine a position in site coordinates of the earthworking machine and the earthworking implement, to receive a signal indicating the location of the at least one underground object, and to provide a real time update to the terrain map of the terrain, and the locations of the earthworking machine, the earthworking implement, and the at least one underground object; and
a display adapted to receive a signal indicating the updated terrain map and to responsively display the location of the earthworking machine, the location of the earthworking implement, and the location of the at least one underground object.

12. An apparatus, as set forth in claim 11, wherein the position determining system includes a global position satellite (GPS) system having a GPS antenna.

13. An apparatus, as set forth in claim 11, wherein the means for determining the location of the at least one underground object includes a map of the excavation site from at least one of a prior installation and a prior sensing of the at least one underground object.

14. An apparatus, as set forth in claim 11, wherein the means for determining the location of the at least one underground object includes means for sensing the location of the at least one underground object.

15. An apparatus, as set forth in claim 14, wherein the means for sensing the location of the at least one underground object includes a ground penetrating radar (GPR) transmitter and receiver.

16. An apparatus, as set forth in claim 11, wherein the controller is further adapted to control the operation of the earthworking implement relative to the location of the at least one underground object.

17. An apparatus, as set forth in claim 16, wherein the controller is further adapted to prevent the earthworking implement from contacting the at least one underground object.

18. An apparatus, as set forth in claim 11, wherein the display is further adapted to display a desired terrain.

19. An apparatus, as set forth in claim 18, wherein the display is further adapted to display at least one icon representing the location of the earthworking machine and the earthworking implement.

20. An apparatus, as set forth in claim 19, wherein the display is further adapted to display at least one of a top view and a side profile view.
